(19) United States
(12) Patent Application Publication
(10) Pub. No.: US 2006/0183546 A1
(43) Pub. Date: Aug. 17, 2006

(54) Baseball simulation device

(76) Inventors: David Ralph Addington, Lake Elsinore, CA (US); Xuejun Tan, Riverside, CA (US); Amro Albanna, Riverside, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/326,097

(22) Filed: Jan. 4, 2006

Related U.S. Application Data
(60) Provisional application No. 60/641,391, filed on Jan. 4, 2005.

(51) Int. Cl. A63F 13/00

(52) U.S. Cl. 463/37

(57) ABSTRACT

Systems and methods are disclosed for a baseball simulation device configured to provide an input for various baseball video games being played on gaming platforms such as a personal computer, PlayStation, PlayStation 2, PlayStation 3, XBOX, XBOX360, and the like. In one embodiment, the simulation device includes a signal emitter assembly attached to a bat, and detector assembly on a base unit shaped like a home plate. Various techniques for detecting different batting moves, such as hits to different directions, bunts, or checked swing, are disclosed. In one embodiment, the base unit can receive a conventional game controller for the gaming platform, thereby allowing operation of the gaming platform without having to remove the simulation device. In one embodiment, the base unit also has changeable firmware that allows different configuration for playing of different baseball video games.

### PRIORITY CLAIM

This application claims the benefit of U.S. Provisional Application No. 60/641,391, filed on Jan. 4, 2005, entitled “Baseball Simulation Device,” which is hereby incorporated by reference in its entirety.

### BACKGROUND

1. Field

The present disclosure relates to electronic gaming technology in general, an in particular, to systems and methods for simulating baseball gaming that can be used with various gaming platforms and game softwares.

2. Description of the Related Art

Video games provide a popular form of entertainment. Games simulating different activities are common. For example, simulation of sporting activities is a popular basis for many video games. Such games are designed to be played on platforms such as a personal computer or a dedicated gaming platform. With improvements in electronic technology, desirable qualities of gaming, such as speed and display/audio quality, have improved greatly.

Despite the vast improvements in hardware and software associated with video games, various simulations are limited in realism due to the limitations of game control devices. For example, games played on a personal computer sometimes rely on mouse or keys to perform various gaming inputs. For games played on dedicated platforms, game controllers are often also limited since such controllers are designed to operate with different types of games.

### SUMMARY

The foregoing needs can be addressed by systems and methods of the present disclosure relating to a baseball simulation device configured to provide an input for various baseball video games being played on gaming platforms such as a personal computer, PlayStation, PlayStation 2, PlayStation 3, XBOX, XBOX360, and the like. In one embodiment, the simulation device can include a signal emitter assembly attached to a bat, and detector assembly on a base unit shaped like a home plate. Various techniques for detecting different batting moves, such as hits to different directions, bunts, or checked swing, are disclosed. In one embodiment, the base unit can receive a conventional game controller for the gaming platform, thereby allowing operation of the gaming platform without having to remove the simulation device. In one embodiment, the base unit also has a changeable firmware that allows different configuration for playing of different baseball video games.

One embodiment of the present disclosure relates to a system for enhancing a simulated baseball game that is displayed on a display and is controllable by a first set of control devices such that user manipulation of the first set of control devices results in control signals in a first format being sent to a game controller such that the game controller generates display signals for displaying a simulated baseball play in accordance with the received control signals. The system includes a baseball bat movement detection system that detects movement and orientation of a bat with respect to a reference location and provides signals indicative thereof. The system further includes a controller that receives the signals and translates the received signals into control signals in the first format such that the baseball bat movement detection system can substitute for the first set of control devices for playing of the simulated baseball game.

In one embodiment, the baseball bat movement detection system includes a bat assembly and a base assembly providing the reference location. The bat assembly and the base assembly include a sensing system that allows detection of the movement and orientation of the bat assembly relative to the reference location. In one embodiment, the bat assembly includes an emitter assembly, and the base assembly includes a sensor assembly. In one embodiment, the emitter assembly includes first and second emitters spaced along the length the bat assembly by a first distance. The base assembly includes first and second sensors that are spaced apart by a second distance, such that the first and second sensors can detect the orientation of the bat assembly as the bat assembly swings over the sensor assembly. In one embodiment, the first distance is approximately the same as the second distance. In one embodiment, the bat assembly includes the emitter assembly that is attachable to a bat.

In one embodiment, the sensor assembly further includes a third sensor positioned on the base assembly so as to allow detection of an approach of the bat to an area above the base assembly. In one embodiment, the base assembly includes a home plate. The first and second sensors are positioned near the side edges near the front of the home plate, and the third sensor is positioned near the rear of the home plate.

In one embodiment, the third sensor provides an initial timing signal for detection of the movement and orientation of the bat assembly. In one embodiment, the first and second sensors provide timing signals that allow determination of orientation of the bat assembly as it swings over the first and second sensors. In one embodiment, a direction of a hit is determined based on the relative timing of activation of the first and second sensors. In one embodiment, the hit is considered to be a straight hit towards a center field if the activation of the first and second sensors occurs within a selected time window. In one embodiment, the hit is considered to be away from the center field if the activation of the first and second sensors occurs outside of the selected time window. In one embodiment, the hit is towards a left field if one of the first and second sensors positioned near the right front of the home plate is activated before the other sensor. In one embodiment, the hit is towards a right field if one of the first and second sensors positioned near the left front of the home plate is activated before the other sensor.

In one embodiment, the third sensor allows detection of a bunt when the third sensor is activated for a selected duration. In one embodiment, the first and second sensors are not activated during the bunt.

In one embodiment, the first and second emitters emit electromagnetic signals. In one embodiment, the electromagnetic signals include infrared signals.

In one embodiment, the first and second emitters emit electromagnetic signals at first and second frequencies, and the first sensor is configured to detect the first frequency signal and second sensor is configured to detect the second frequency signal. In one embodiment, the first and second emitters can be switched between a first mode where the first and second signals have the first and second frequencies, respectively, and a second mode where the first and second signals have the second and first frequencies, respectively, thereby allowing use of the bat assembly by either a right handed or left handed user. In one embodiment, the third sensor is configured to detect both first and second frequency signals.

In one embodiment, the base assembly is configured to receive at least some of the first set of control devices such that the simulated baseball game can be played using either or both of the at least some of the first set of control devices and the baseball bat movement detection system.

In one embodiment, the base assembly includes one or more user-operated input devices that facilitate playing of the game in conjunction with the baseball bat movement detection system. In one embodiment, the one or more user-operated input devices provide instructions for base running plays.

In one embodiment, the base assembly includes a firmware component that can be used to change an existing firmware to accommodate different video game softwares for different gaming platforms, including, for example, a personal computer, PlayStation, PlayStation 2, PlayStation 3, XBOX, XBOX360, and the like.

In one embodiment, the simulated baseball game is played on a personal computer. In one embodiment, the simulated baseball game is played on a dedicated gaming platform such as PlayStation, PlayStation 2, PlayStation 3, XBOX, and XBOX360.

Another embodiment of the present disclosure relates to a method for enhancing a simulated baseball game that is displayed on a display and is controllable by a first set of control devices such that user manipulation of the first set of control devices results in control signals in a first format being sent to a game controller such that the game controller generates display signals for displaying a simulated baseball play in accordance with the received control signals. The method includes detecting movement and orientation of a bat with respect to a reference location and providing signals indicative thereof. The method further includes receiving the signals and translating the received signals into control signals in the first format so as to substitute for the first set of control devices for playing of the simulated baseball game.

Another embodiment of the present disclosure relates to a system for enhancing a simulated baseball game. The system includes means for detecting movement and orientation of a bat with respect to a reference location. The system further includes means for generating and providing signals indicative of the movement and orientation of the bat.

Another embodiment of the present disclosure relates to a system for enhancing a simulated baseball game that is displayed on a display and is controllable by a first set of control devices such that user manipulation of the first set of control devices results in control signals in a first format being sent to a game controller such that the game controller generates display signals for displaying a simulated baseball play in accordance with the received control signals. The system includes a bat assembly and a base assembly. The system further includes a plurality of signal emitters and a plurality of sensors. Each sensor is configured to detect signals from one or more of the plurality of signal emitters. The plurality of signal emitters and the plurality of sensors are positioned on the bat assembly and the base assembly. At least one of the plurality of signal emitters or the plurality of sensors is positioned on the bat assembly. At least one of the plurality of signal emitters or the plurality of sensors is positioned on the base assembly, such that sensing of the emitted signals by the plurality of sensors allows determination of movement and orientation of the bat assembly relative to the base assembly.

In one embodiment, the plurality of signal emitters are positioned on the bat assembly, and the plurality of sensors are positioned on the base assembly. In one embodiment, the plurality of signal emitters are positioned on the base assembly, and the plurality of sensors are positioned on the bat assembly.

### BRIEF DESCRIPTION OF THE DRAWINGS

FIG. 1 shows one embodiment of a baseball simulation device in use with a gaming platform;

FIG. 2 shows one embodiment of the baseball simulation device having a base portion and a bat portion;

FIG. 3 shows one embodiment of the bat portion having an attachable signal emitter assembly;

FIG. 4 shows an example of how a relative position of the bat can be detected via detection of the emitted signals by a sensor assembly in the base portion;

FIG. 5A shows an example configuration of the emitter assembly and the sensor assembly that allows detection of different types of bat swings;

FIG. 5B shows that in one embodiment, the example bat configuration of FIG. 5A can be switched to accommodate left-handed batting;

FIGS. 6A-6C show examples of different types of swings that can be detected;

FIGS. 7A-7C show example directions of hits that can result from the example swings of FIGS. 6A-6C;

FIG. 8 shows that in one embodiment, other types of swings such as a checked swing and a bunt can be detected;

FIG. 9 shows an example configuration of a sensor assembly that generates an example binary timing signal in response to detection of a signal emitted from an emitter on the bat;

FIG. 10 shows example timing signals corresponding to a swing;

FIG. 11 shows example timing signals corresponding to a checked swing or a bunt;

FIG. 12 shows that in one embodiment, an extra sensor can be used to facilitate distinguishing of a checked swing from a bunt;

FIGS. 13A and 13B shows example timing signals corresponding to checked swings;

FIG. 13C shows example timing signals corresponding to a bunt;

FIG. 14 shows one embodiment of the base portion having a plurality of user input devices that facilitates various gaming inputs;

FIG. 15 shows one embodiment of a process configured to determine different types of bat swings;

FIG. 16 shows one embodiment of the base portion configured to receive one or more gaming controllers for the gaming platform;

FIG. 17 shows that in one embodiment, the base portion can be configured to allow changing of firmware to allow operation with different softwares; and

FIG. 18 shows one embodiment of the baseball simulation device where the emitters can be positioned on the base unit and the sensors on the bat.

These and other aspects, advantages, and novel features of the present teachings will become apparent upon reading the following detailed description and upon reference to the accompanying drawings. In the drawings, similar elements have similar reference numerals.

### DETAILED DESCRIPTION OF SOME EMBODIMENTS

The present disclosure generally relates to electronic gaming, and in particular, to systems and methods for an alternative input device to serve as a source of input for various baseball video games. In some embodiments, the baseball simulation device of the present disclosure can provide source inputs for baseball gaming situations such as batting and base-running.

Computer video games for which the simulation device of the present disclosure can be used can be from one of many game developers. The gaming hardware platform can be a personal computer or one of the dedicated gaming platforms such as, but not limited to, PlayStation, PlayStation 2, PlayStation 3, XBOX, XBOX360, etc. In some embodiments, the simulation device can have the ability to provide appropriate input for a given platform and game software using required input electrical standards and software protocols to generate effects such as bat-swinging or base-running.

In the description herein, it will be assumed that various batting moves are performed by a right-handed batter, unless otherwise stated. Such description should not be construed in any way as limiting the scope of the present disclosure.

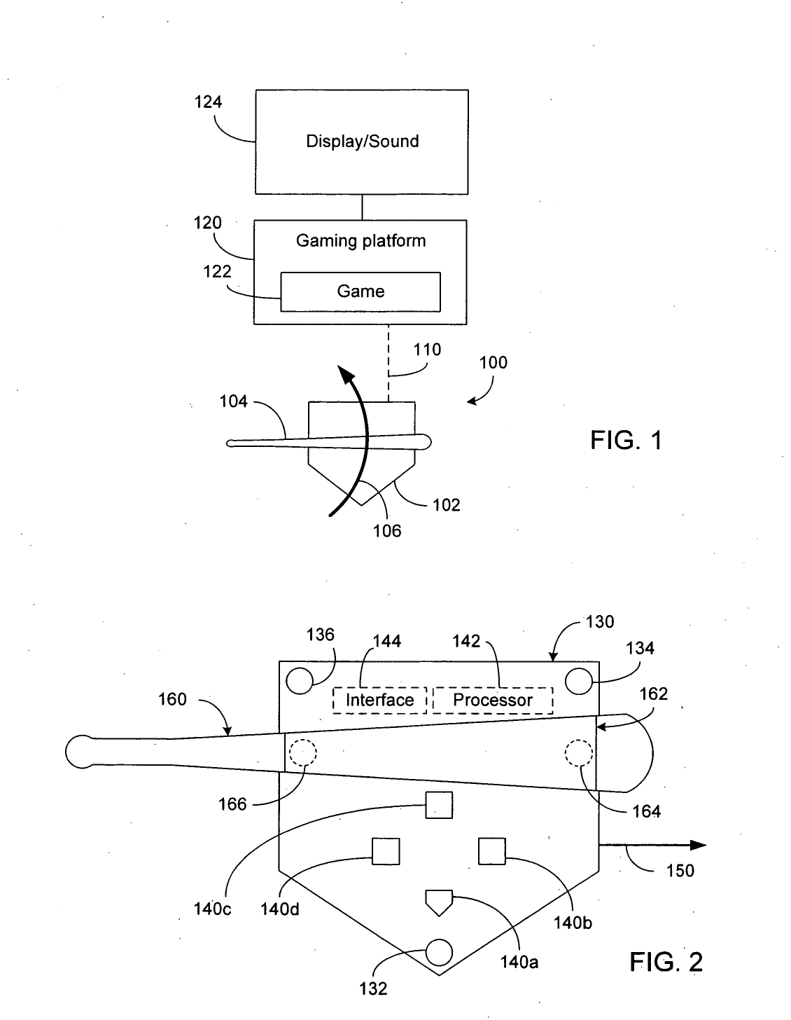

FIG. 1 shows one embodiment of a baseball simulation device 100 that can be configured to determine different types of swings (depicted as an arrow 106) of a bat or bat-like apparatus 104 over a base unit 102. In one embodiment, the base unit 102 is shaped like a home plate.

As further shown in FIG. 1, the base unit 102 is linked to a gaming platform 120, as indicated by a dashed line 110. The link 110 can be cable-based or wireless.

The gaming platform is configured to allow playing of a game 122 such as a baseball simulation game. Visual and audio effects of the game 122 can be manifested via an output device 124 such as screen and speaker(s).

FIG. 2 shows one embodiment of a bat or bat-like apparatus 160 having a plurality of emitters 164 and 166 positioned generally along the length of the bat 160 and separated by a selected distance. FIG. 2 also shows one embodiment of a base unit 130 having a plurality of sensors 132, 134, and 136 arranged at selected positions.

In one embodiment, the sensors 134 and 136 can be arranged to detect signals emitted from the corresponding emitters 164 and 166, to thereby allow determination of the orientation of the bat 160 when the bat 160 passes over the home plate 130. For the purpose of description herein, the sensors 134 and 136 are sometimes referred to as “swing” sensors.

In one embodiment, the swing sensors 134 and 136 are positioned near the front of, and spaced to be close to the width of, the home plate 130. In one embodiment, the emitters 164 and 166 are spaced by the selected separation distance that is similar to the spacing of the swing sensors 134 and 136.

In one embodiment, the sensor 132 can be positioned near the back portion of the home plate 130, thereby being able to detect the bat 160 first as it approaches the home plate 130. Thus, the sensor 132 can trigger a sequence of timing for various sensors so as to allow determination of different types of swings. The sensor 132 can also be used to detect checked swings and bunts. Examples of determining these various types of batting moves are described below in greater detail.

As further shown in FIG. 2, one embodiment of the base unit 130 can include a plurality of user input devices 140, such as buttons, that can facilitate various gaming inputs in addition to, or in conjunction with, gaming inputs generated by different types of batting moves. Such input(s) for the gaming platform (120 in FIG. 1) is depicted as an output 150 in FIG. 2. Examples of gaming inputs that can be generated by the user input devices 140 are described below in greater detail.

In one embodiment, as shown in FIG. 2, the home plate unit 130 can include a processor component 142 and an interface circuitry component 144. The processor component 142 can be configured to receive and process various signals received from the sensors. The interface component 144 can be configured to functionally interconnect the sensors to the processor component 142. The interface component 144 can also provide an interface with the gaming platform.

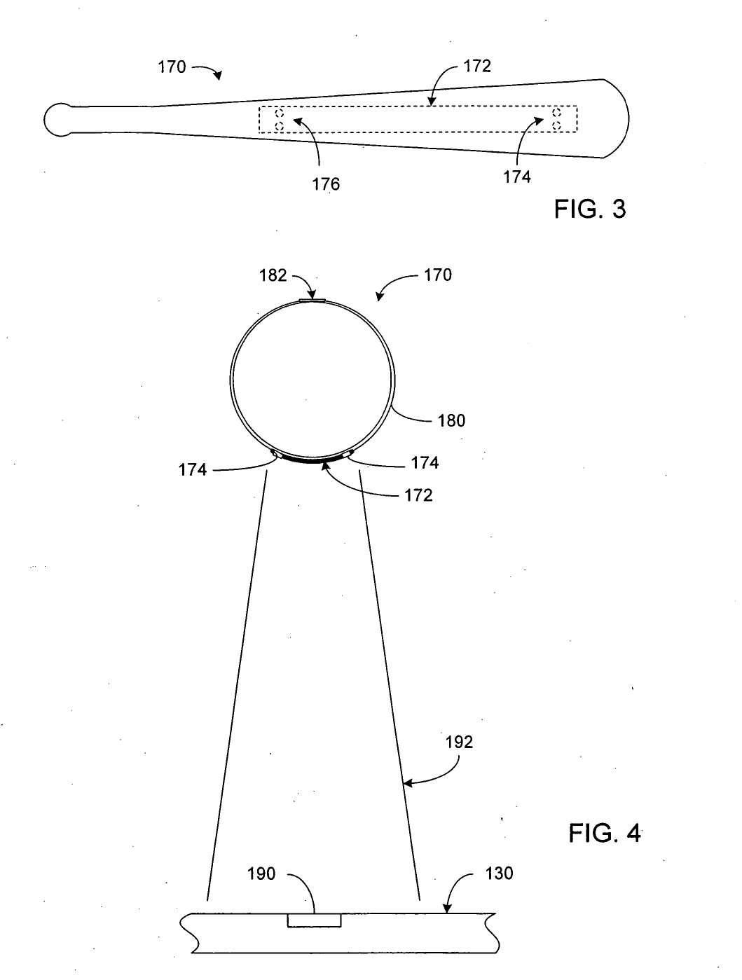

FIG. 3 shows one embodiment of a bat 170 having a plurality of emitters 174, 176. The emitters can be an integral part of a dedicated gaming bat unit, or can be a part of an attachable unit 172 that can be attached to different bats or bat-like items. Preferably, the bat 170 is held so that the emitters 174 and 176 emit the signals generally towards the sensors on the base unit. Thus, the example attachable emitter assembly 172 is depicted as being attached to the bottom surface of the bat 170 when the bat 170 is held generally above the base unit.

In one embodiment, one or more emitters can be positioned at locations indicated as 174 and 176. In one embodiment, a single emitter is positioned at each of the two emitter locations 174 and 176. In one embodiment, two emitters are positioned and arranged along the circumference of the bat at each of the two emitter locations 174 and 176.

FIG. 4 shows an end view of the example bat assembly 170 of FIG. 3. The emitter assembly 172 is shown to be attached to the bottom portion of the bat. In the example configuration shown, two emitters 174 are shown to be arranged along the circumference of the bat 170. Such an arrangement of emitters can make the bat orientation less critical, and thereby can provide an improved coverage of the emitted signals over the detectors positioned on the home plate. An example depiction of coverage is indicated as 192, where the signal coverage can be greater than the physical dimension of a detector 190 in or on the home plate 130.

As further shown in FIG. 4, an example attachment member 180 secures the emitter assembly 172 to the bat. The attachment member 180 is shown to include a securing member 182 that can facilitate attachment and removal of the emitter assembly to and from the bat. The securing member can include, for example, Velcro-type or buckle-type arrangements.

In one embodiment, the emitter assembly 172 can be a part of a sleeve that fits around a bat. The bat sleeve does not necessarily have to completely enclose the circumference of the bat. In one embodiment, such as the example shown in FIG. 4, the sleeve encircles about sixty degrees of angular coverage about the axis of the bat.

In some embodiments, the emitters and sensors can include but not limited to devices that operate at various ranges of electromagnetic radiation—e.g., infrared, visual, ultraviolet, radiofrequency, etc. In one embodiment, the emitters and sensors can also include but not limited to hypersonic emitters and receivers.

In one embodiment, the emitters and sensors operate at infrared (IR) frequencies. As an example, sensors can include detectors such as Panasonic PNA4611 M series devices that can operate at various frequencies. In one embodiment, detectors operating at approximately 38 KHz and 56.9 KHz are used. Use of two distinguishable frequencies is described below in greater detail. In one embodiment, emitters can include LEDs driven to operate at frequencies corresponding to those of the detectors. Thus for example, LEDs can be driven so that one set flashes at approximately 38 KHz and the other set at 56.9 KHz. Again, it will be understood that the IR signal is an example, and other types of signals can be used.

In one embodiment, the swing sensors (134 and 136 in FIG. 2, for example) operate at different frequencies so as to reduce the likelihood that a given sensor will cross-detect a signal from a wrong emitter. Accordingly, the corresponding emitters on the bat can be configured to also operate at the corresponding frequencies.

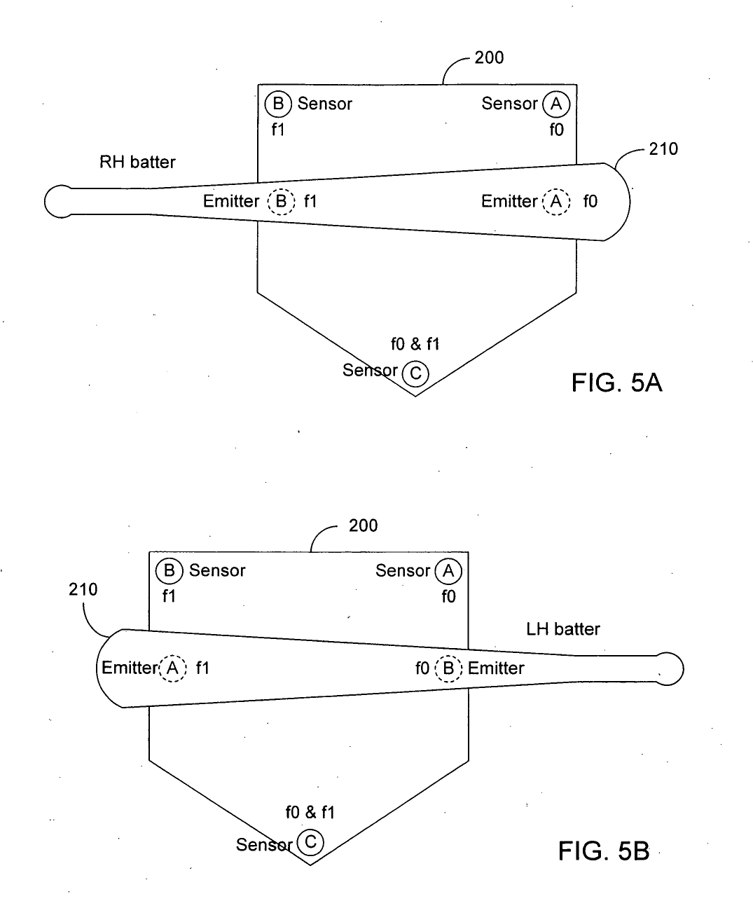

FIG. 5A shows one embodiment of the simulation device where a base unit 200 and a bat 210 are configured so that swing sensors (and the corresponding emitters) operate at different frequencies to reduce the likelihood of cross-detection of wrong signals. For example, the emitter “A” and the corresponding sensor “A” can be configured to operate at a frequency of f0; and the emitter “B: and the corresponding sensor “B” can be configured to operate at a frequency of f1 that is different than f0. As further shown in FIG. 5A, the sensor “C” positioned near the back of the home plate does not need to be emitter-specific. Thus, the “C” sensor can be configured to be sensitive to both frequencies f0 and f1.

The example configuration shown in FIG. 5A is for a right-handed batter. In one embodiment, the simulation device can be used by a right-handed batter as well as a left-handed batter.

FIG. 5B shows one embodiment of the simulation device configured to allow use by a left-handed batter. In one embodiment, the emitters A and B on the bat 210 can be made to operate at either f0 or f1 frequency. Thus, in the right-handed configuration of FIG. 5A, the emitter A can operate at f0, and emitter B can operate at f1. In the left-handed configuration of FIG. 5B, the emitter A can operate at f1 (to match the sensor B), and emitter B can operate at f0 (to match the sensor A). In one embodiment, such switching of frequencies can be effectuated by a simple switch (not shown) on the emitter assembly.

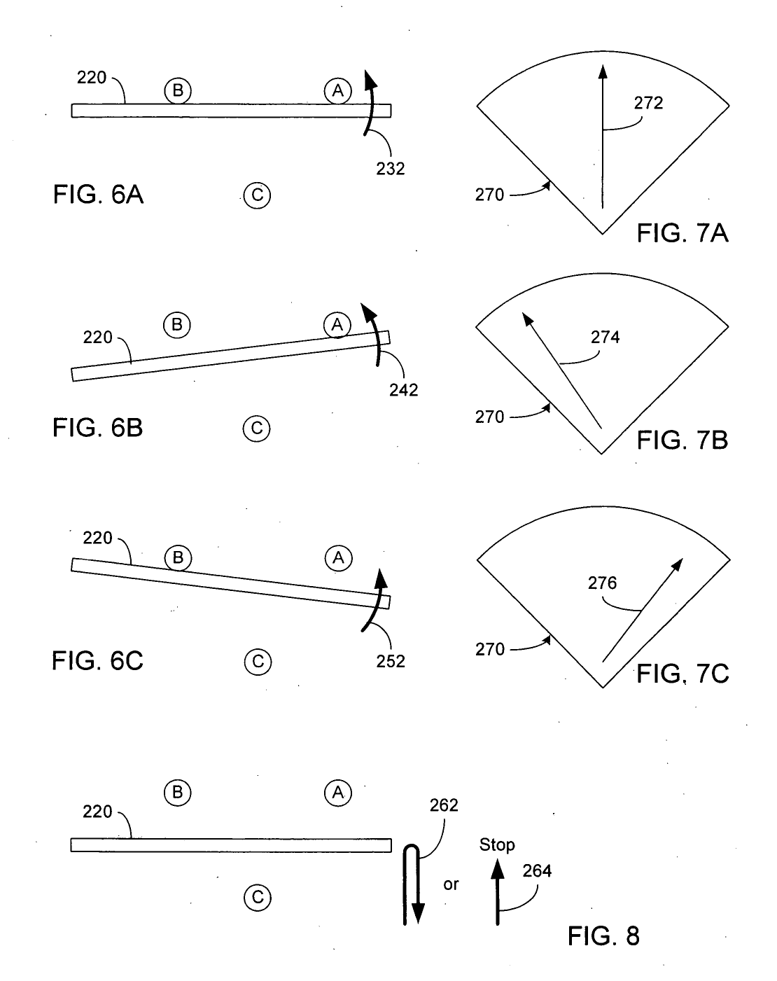

Based on the foregoing examples of selective detection of signals, different types of swings can be detected and appropriate input can be provided to the simulation game. FIGS. 6A-6C show examples of different bat orientations that can result in different swings. FIGS. 7A-7C show corresponding directions of hits that can result from the example swings of FIGS. 6A-6C. For the purpose of description, a right-handed batting is depicted.

FIG. 6A shows an example of a straight swing 232 that can result in a hit 272 towards a center of a baseball field 270. For such a swing, a bat 220 is shown to be detected (emitters not shown) by the swing detectors A and B at approximately the same time. In one embodiment, a swing is considered to be a straight swing if the detection at the A and B detectors occur within some selected time window.

FIG. 6B shows an example of a swing 242 that can result in a hit 274 towards a left field. For such a swing, the far end portion (emitter A in FIG. 5A) of the bat 220 is shown to be detected by the swing detector A before the detection of emitter B by the swing detector B. In one embodiment, a swing is considered to be a non-straight swing if the detection at the A and B detectors occur outside of the selected time window.

FIG. 6C shows an example of a swing 252 that can result in a hit 276 towards a right field. For such a swing, the far end portion (emitter A in FIG. 5A) of the bat 220 is shown to be detected by the swing detector A after the detection of emitter B by the swing detector B. In one embodiment, a swing is considered to be a non-straight swing if the detection at the A and B detectors occur outside of the selected time window.

In baseball, not all swings are followed through. A batter may “check” the swing, or may position the bat to bunt the ball. The simulation device of the present disclosure can simulate such non-full-swing batting moves.

FIG. 8 shows that a swing of the bat 220 can be checked (as indicated by an arrow 262) so that the bat 220 is stopped from a full swing and retreated backwards. The bat 220 can also be brought to an area above the home plate from the rear and held in that position for some duration to bunt the ball. In one embodiment, such batting moves can be detected by lack of signals from A and B sensors, and/or some property of the detected signal from the sensor C. Examples of checked-swing and bunt are described below in greater detail.

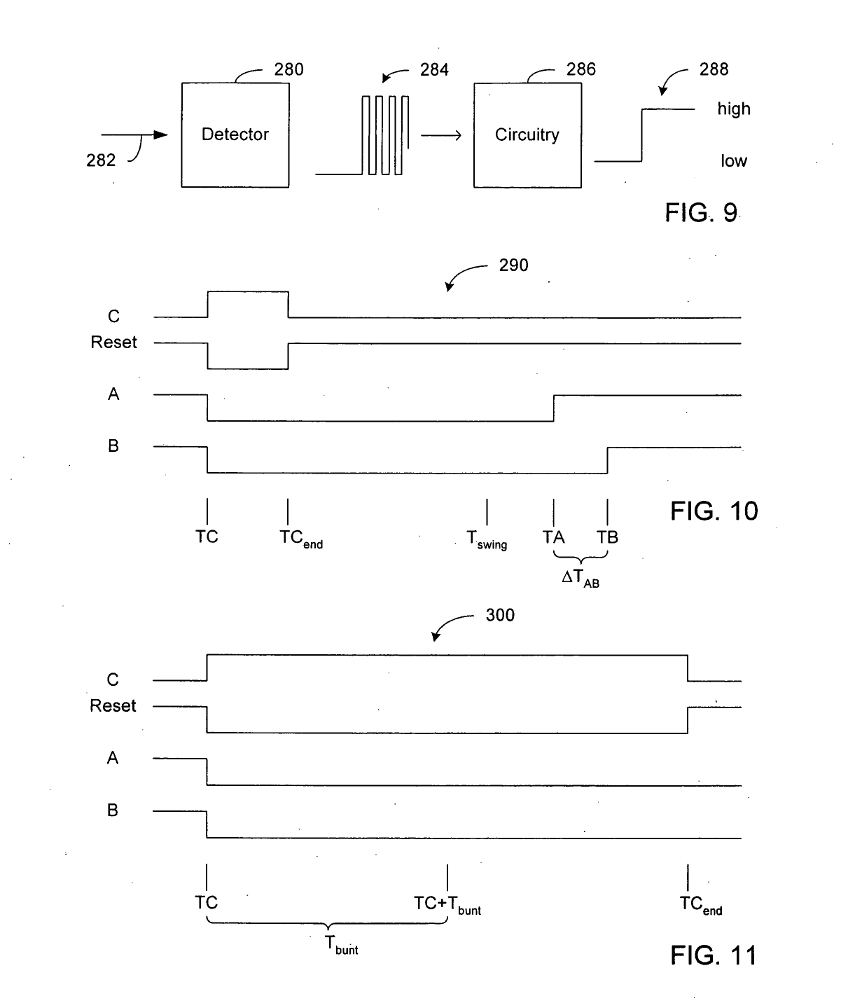

In one embodiment, various swing types and other batting moves can be determined based on signal(s) obtained from one or more of the sensors in response to detection of emitted signal(s). FIG. 9 shows that in one embodiment, a detector 280 and a corresponding signal processing circuitry 286 can be configured to generate an example binary state logic signal 288 in response to detection of a signal 282. The example detector 280 is shown to generate an output signal 284 in response to detection of the signal 282. The output signal 284 is further shown to be processed by the circuitry 286 to generate the example logic signal 288.

In one embodiment, the foregoing generation of logic signal can be achieved by passing the detector output signal 284 through the circuitry 286 that latches the signals at a high level at the first appearance of a rising signal edge on the output signal 284. In one embodiment, such latching can be accomplished by using what is commonly known as a D flip-flop applying the sensor signal to the clock input of a flip-flop and holding the D input of the flip-flop at a high level. When using this example configuration, the flip-flop typically needs to be reset before it is again able to trigger on a rising edge of the signal. In one embodiment, a signal from the sensor C can serve as a source for resetting the flip-flops. At the first appearance of a rising edge from the sensors A and B, the outputs of the flip-flops for each respective signal source can switch to a high, or active, state. Various example timing configurations are described below in greater detail.

FIG. 10 shows an example timing configuration 290 corresponding to an example swing. As the bat swings above the home plate, it first passes over the C detector (see FIGS. 6A-6C, for example) between the times TC and TC_{end}. Accordingly, a logic signal corresponding to detector C is shown to be in a “high” state, beginning from TC and ending at TC_{end}. When “C” goes high, a reset logic signal is shown to reset the swing sensor logic signals to a “low” state.

As further shown in FIG. 10, detector A is shown to transition to a high state at time TA, indicating that emitter A of the bat is detected by detector A. At time TB, detector B is shown to transition to a high state, indicating that emitter B of the bat is detected by detector B. The difference in time between TB and TA is shown to be ΔT_{AB}.

In one embodiment, ΔT_{AB} can be defined as TB−TA. The example swing 290 can be considered to be a straight swing if the absolute value of ΔT_{AB} (|ΔT_{AB}|) is less than some selected value. If |ΔT_{AB}| is greater than the selected value, the swing can be considered to be a left-field swing (ΔT_{AB}>0) or a right-field swing (ΔT_{AB}<0).

In one embodiment, a valid swing can require that the swing sensors be triggered after some reasonable time after time TC (indicated as T_{swing} in FIG. 10). Thus, if either of the swing sensors trigger prior to T_{swing}, then such sequence of logic may be considered to be a non-swing.

In one embodiment, the value of ΔT_{AB} can be used to determine how left (ΔT_{AB}>0) or right (ΔT_{AB}<0) a resulting hit is directed. A greater magnitude of ΔT_{AB} can be translated to a hit that goes more left or right. If the magnitude of ΔT_{AB} exceeds some value, then the resulting hit can be considered to be a foul ball.

In one embodiment, the timing of signals from the swing sensors A and B can depend on the speed of bat swing. For example, consider two swings where the bat orientation is similar when passing over the swing sensors—say that A triggers before B, similar to that of FIG. 6B. The first swing is a slow swing, so that the ΔT_{AB} has a first value, and the second swing is a fast swing, so that ΔT_{AB} has a second value that is less than the first value. Thus, if only the relative timing of the swing sensors is used, the directionality of the resulting hit may not account for the bat speed.

In another example, consider two swings where the bat orientations are different, but share a common value for ΔT_{AB} due to different swing speeds. Again, if only the relative timing of the swing sensors is used, these two example swings may yield a similar hit.

In one embodiment, a bat swinging speed can be taken into account when determining the direction of a hit resulting from a given swing. In one embodiment, such incorporation of the bat speed can be achieved through the use of sensor C. The period of the time between activation of sensor C and first of the swing sensors (A or B) is dependent on the bat swing speed. Thus, the value of ΔT_{AB} (or any other timing parameter) can be normalized based on the bat swing speed.

In one embodiment, a direction of a hit resulting from a swing can also be adjusted according to the timing of the swing relative to a given pitch. For example, if the bat is swung too early before the virtual ball arrives at the home plate, the resulting hit can be made to send the ball towards the left field or foul territory, even if the bat was oriented for a right-field hit when over the home plate. Similarly, if the bat is swung too late, the resulting hit can be made to send the ball towards the right field or foul territory, even if the bat was oriented for a left-filed hit when over the home plate.

In some baseball simulation games, a player can choose which field (left, center, or right) he or she would like the hit to go to. To make such a selection, the player, if not using the simulation device of the present disclosure, makes a predetermined selection (for example, by pressing a particular button). Then, a swing is made. Whether or not such desired hit directionality occurs depends on the timing of the swing with respect to a pitch.

Using one embodiment of the simulation device of the present disclosure, the foregoing directionality selection can be effectuated where the predetermined selection process is replaced by the hit directionality as determined by the swing orientation. In one embodiment, whether or not such desired directionality occurs can depend of the timing of the swing with respect to a pitch. Thus, one can see that use of the simulation device can greatly enhance the realism of baseball simulation games.

In one embodiment, the desired directionality can be further refined beyond the left, center, or right selection, if a given baseball simulation game is configured accordingly. For example, a swing can determine how far to the left or right the player prefers the hit to be. In one embodiment, such degree of directionality preference can be estimated as a function of the time differential in the activation of the swing sensors. For example, a proportional relationship can translate the time differential to the degree of directionality preference. In one embodiment, whether or not such desired degree of directionality preference occurs can depend of the timing of the swing with respect to a pitch.

FIG. 11 shows an example timing configuration 300 corresponding to an example bunt. As the bat is brought to the bunt position above the home plate, it passes over the C detector (see FIG. 8, for example) at time TC, and generally remains over the home plate until time TC_{end}. Accordingly, a logic signal corresponding to detector C is shown to be in a “high” state, beginning from TC and ending at TC_{end}. When “C” goes high, a reset logic signal is shown to reset the swing sensor logic signals to a “low” state.

In one embodiment, a bunt is considered to occur when the duration of the high state of C is longer than some selected bunt duration T_{bunt}, regardless of whether the swing sensors trigger or not. In some situations, one or more of the swing sensors may trigger when the bat hovers over the home plate. Thus, the presence of a swing sensor signal may be ignored when the C sensor logic signal lasts longer than the duration T_{bunt}.

In one embodiment, an absence of signals from the swing sensors can indicate either a bunt or a checked swing. In one embodiment, a bunt can occur when the bat hovers above the home plate, but sufficiently far back so that sensor C is activated without activating the swing sensors. In one embodiment, a checked swing can occur when sensor is activated for some duration while the bat moves forward over sensor C, stops before activating the swing sensors, and possibly moving backward away from the home plate. Thus, a timing diagram for a checked swing can sometimes appear to be similar to a timing diagram for a bunt.

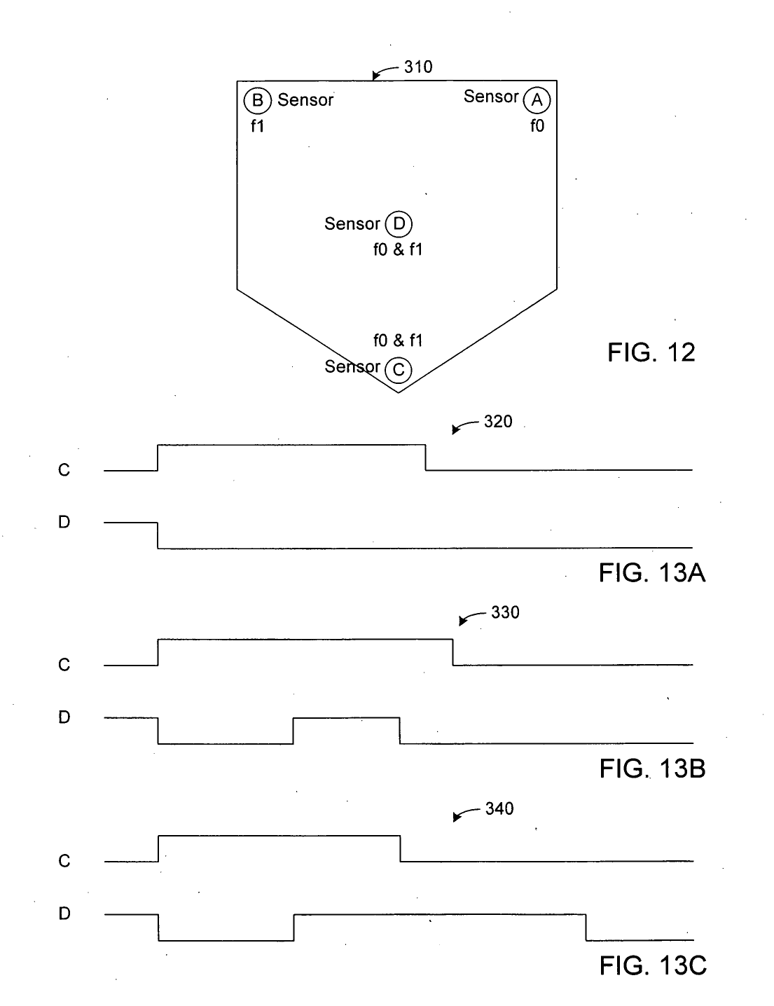

FIG. 12 shows one embodiment of a base unit 310 having an additional sensor “D” positioned between sensor C and the swing sensors A and B. In one embodiment, sensor D can be configured to be similar to sensor C, so as to be sensitive to both of the operating frequencies f0 and f1. Use of sensor D can facilitate differentiation between a bunt and a checked swing.

FIGS. 13A-13C show example timing diagrams corresponding to a check swing or a bunt. For the purpose of describing FIGS. 13A-13C, it will be assumed that the swing sensors A and B are not activated.

FIG. 13A shows an example situation 320 where only sensor C is activated for some duration. Such a situation can occur when the bat is passed over sensor C, and “checked” before activating sensor D. Thus, the example timing pattern 320 can indicate an incomplete swing that is checked prior to the bat reaching sensor D. In one embodiment, some reasonable time duration can be allowed for the appearance for other sensor signals. If no other sensors are activated within that duration, the example timing pattern 320 can be considered as a checked swing.

FIG. 13B shows another example situation 330 that can indicate a checked swing. In this example, the checking of the swing occurs at a location more forward than that of FIG. 13A. Thus, sensor D is activated for a relatively short duration as the bat is retracted backwards, out of the range of sensor D, and back over sensor C.

FIG. 13C shows an example situation 340 that can indicate a bunt. In this example, the bat is brought to the bunt position over the home plate. As the bat is brought to such a position, it passes over sensor C, and can hover over sensor D. Thus, sensor C is shown to be activated first, followed by sensor D. Sensor C is shown to become inactive while the bat hovers over sensor D. If the bat hovers over some region between sensors C and D, sensor C may remain active along with sensor D.

In one embodiment where both sensors C and D are activated, a bunt is considered to have occurred if sensor D is active for a relatively long duration when compared to active duration of sensor C. If sensor D is active for a duration that is shorter than the active duration of sensor C, a checked swing can be considered to have occurred.

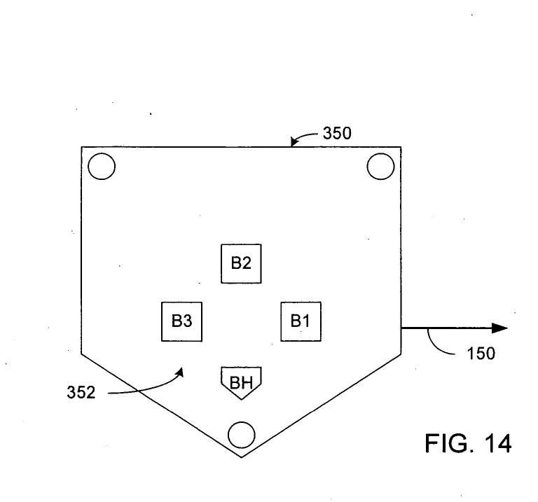

As previously described in reference to FIG. 2, the base unit can include a plurality of user input devices that can provide inputs in addition to, or in conjunction with, the various inputs generated by different types of batting moves. FIG. 14 shows one embodiment of a base unit 350 having a plurality of user input devices 352, such as buttons, that are arranged into a pattern similar to a baseball diamond. Thus, the example buttons are indicated as BH (home base), B1 (first base), B2 (second base), and B3 (third base).

In one embodiment, one or more of the user buttons 352 can be pressed (for example, by stepping on them) during the simulated play. Table 1 lists some example actions that can be effectuated by different buttons or different combinations of buttons.

TABLE 1

| Button(s) pressed | Action |
|---|---|
| B2 only | Swing up when sending swing data. |
| BH only | Swing down when sending swing data. |
| BH and B1 only | Advance all players. |
| BH and B3 only | Retreat all players. |
| B1 and B2 only | Steal from first to second base. |
| B2 and B3 only | Steal from second to third base. |
| All four buttons | Charge the mound. |

As one can see, there are a number of different actions that can be taken using different combinations of the user input devices. In one embodiment, the home plate foot activated user input devices can control actions associated with base running. Such actions can include, but are not limited to, slide types such as head first slide, feet first slide, pop-up slide in addition to which direction of the base the runner wishes to slide to.

One game may have a feature that is not available in another game. Thus, as described below in greater detail, the base unit can be configured to operate with different games.

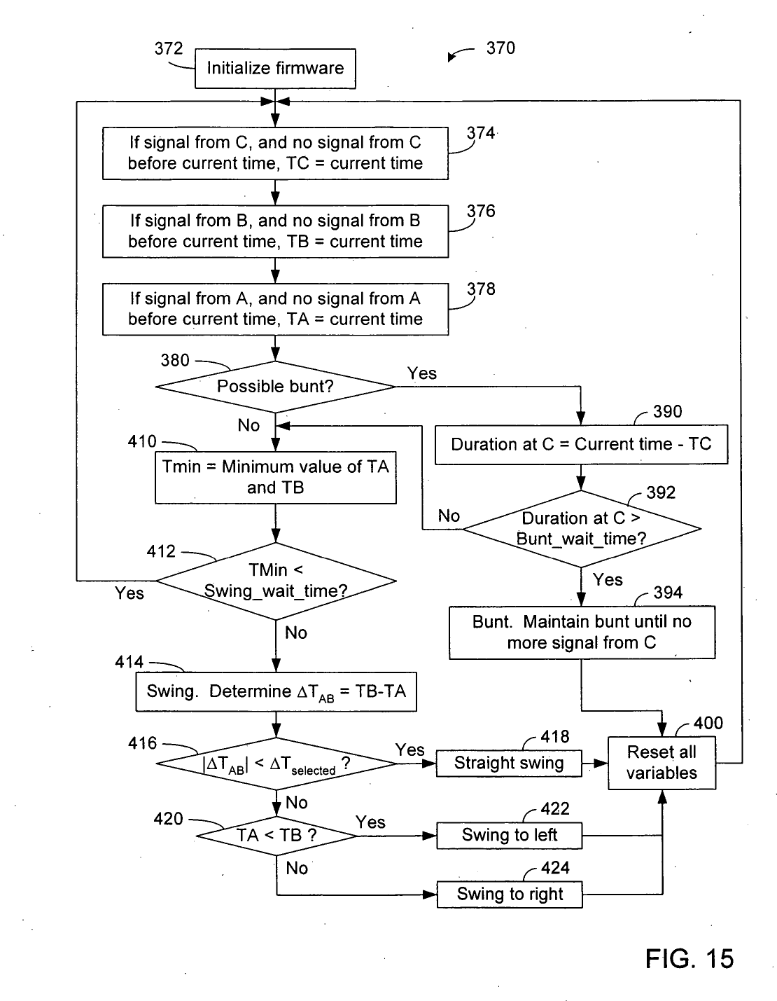

FIG. 15 shows one embodiment of a process 370 that can perform various features as described herein. In a process block 372, firmware is initialized. In process blocks 374, 376, and 378, an assignment is made where TC, TB, and TA are assigned current time value when the corresponding sensor is activated.

In one embodiment, a bunt is considered to be possible if sensor C is activated. Thus, in a decision block 380, the process 370 determines whether a bunt is possible. If the answer is “Yes,” the process 370 in a process block 390 determines the duration of sensor C being active. In one embodiment, such duration can be determined by taking the difference between the current time and the value of TC obtained in the process block 374. In a decision block 392, the process 370 determines whether the duration of sensor C is greater than a predetermined duration Bunt_wait_time. If the answer to the decision block 392 is “No,” there is no bunt, and the process 370 proceeds as a “No” answer to the decision block 380 in a manner as described below. If the answer to the decision block 392 is “Yes,” a bunt is considered to have been made in a process block 394, and the bunt is maintained until sensor C becomes inactive. In one embodiment, signals (if any) from the swing sensors are ignored when sensor C is active for a duration greater than Bunt_wait_time. Such a scheme can reduce the likelihood of accidental or spurious activation(s) of the swing sensors interfering with the bunt determination. In a process block 400, all timing variables are reset, and the process returns to process blocks 374, 376, and 378 to obtain parameters for the next batting.

If the answer to the decision block 380 is “No,” then no bunt is performed. In a process block 410, a minimum value (Tmin) among TA and TB is obtained. In one embodiment, such a value corresponds to the earliest activation of the swing sensor after activation of sensor C. In a decision block 412, the process 370 determines whether TMin is less than a predetermined value Swing_wait₁₃ time. If the answer to the decision block 412 is “Yes,” the swing is considered to be not valid, and the process returns for the next swing. If the answer to the decision block 412 is “No,” a valid swing is considered to have been made in a process block 414. The swing sensor activation time difference ΔT_{AB} is also obtained.

As shown in FIG. 15, the swing is considered to be a straight swing (process block 418) if the absolute value of ΔT_{AB} is less than a predetermined value ΔT_{selected}. If ΔT_{AB} is greater than ΔT_{selected}, and ΔT_{AB} is positive, the swing is considered to be to the left (process block 422). The swing is considered to be to the right (process block 424) if ΔT_{AB} is negative. Once the type of swing is determined as one of process blocks 418, 422, or 424, the process 370 resets all timing variables in the process block 400 and returns for the next swing.

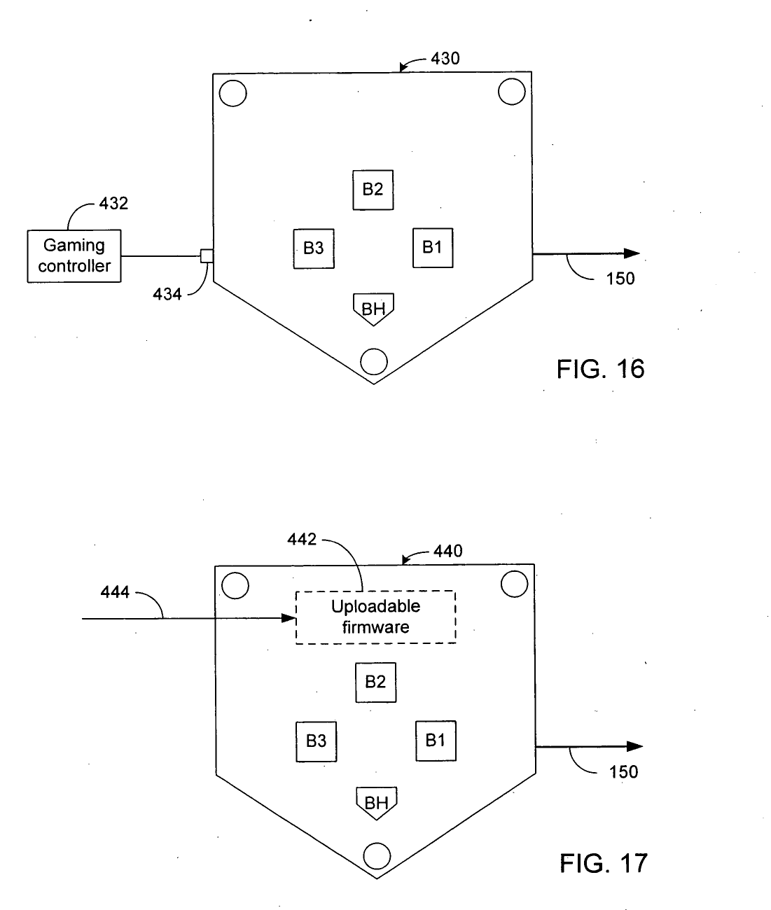

FIG. 16 shows that in one embodiment, a base unit 430 can be configured to receive a gaming controller 432 that is intended to be connected to a gaming platform (not shown). In one embodiment, the gaming controller 432 can be plugged into the base unit 430 via a connector 434 that is similar to that found on the gaming platform.

The foregoing feature shown in FIG. 16 can allow the gaming controller 432 to control the gaming platform via the link 150, even when the base unit 430 is interposed between the gaming controller 432 and the gaming platform. Thus, one can see that the gaming platform can be used to play other games without removing the base unit 430. In one embodiment, the gaming controller 432 can facilitate playing of a baseball simulation game being played with the base unit 430.

In one embodiment, inputs are sent from the baseball system (base unit) to the gaming system hardware through interfaces provided by the hardware. In the case of a personal computer based system, the baseball system inputs can emulate a Universal Serial Bus (USB) keyboard or a mouse. The baseball system can send signals corresponding to the appropriate keystroke or mouse click for the specific gaming software to effectuate a swing during batting situations. In the event where the simulated player in the game is base-running, the baseball system can provide inputs that are mapped to base-running actions within the gaming software and system. When the baseball system is being used with a personal computer having USB functionality, no switching is required when the player wants to play other games, since USB input systems on many personal computers allow receiving of inputs from more than one device.

In one embodiment, implementation of the baseball system on dedicated gaming platforms, such as PlayStation, PlayStation 2, PlayStation 3, XBOX, XBOX360, and the like, can involve outputs from the baseball system simulating the outputs of the dedicated controller outputs. Moreover, in one embodiment, implementation of a switching scheme for gaming platform hardware may be necessary for gaming platforms such as PlayStation, PlayStation 2, PlayStation 3, XBOX, XBOX360, and the like. The switch can be implemented to substantially always provide power to both attached input controller devices so that they are substantially always powered on, thus avoiding a situation where each device runs initialization routines each time it is switched on. In one embodiment, only the data lines are switched at the electrical level between the standard controller input device and the baseball system.

As described herein, the baseball simulation system of the present disclosure can provide various functionalities for different games played on different platforms. Thus, it is preferable to provide the simulation system with some flexibility in configuration that allows use of the same system for different games.

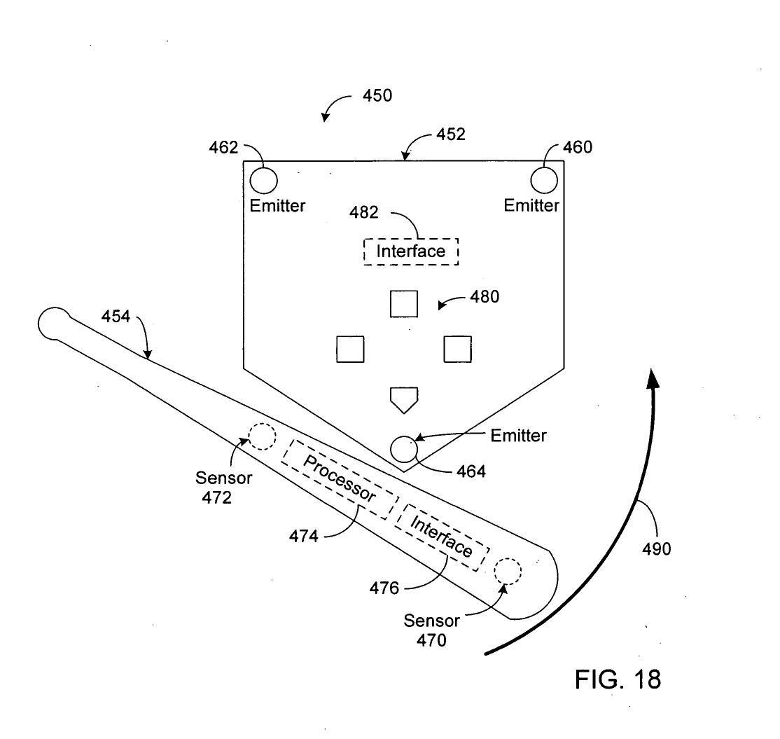

FIG. 17 shows that in one embodiment, a base unit 440 can include a component 442 that can be used to change an existing firmware to accommodate different video game softwares for different gaming platforms, including, for example, a personal computer, PlayStation, PlayStation 2, PlayStation 3, XBOX, XBOX360, and the like. In one embodiment, such change of firmware can be achieved by uploading (depicted as an arrow 444). For example, a given game may have a feature where charging of the mound is an option play. The example actions of Table 1 (in particular, pressing of all four buttons) can accommodate such a play. Thus, it is generally preferable to allow the base unit 440 to be configurable to allow execution of different plays, some of which can be game-specific.

In some embodiments, the changeable firmware can allow the simulation device to provide appropriate input for a given platform and game software using required input electrical standards and software protocols associated with the platform and software.

FIG. 18 shows that in one embodiment, at least some functionalities of the base assembly can be implemented on the bat assembly. Similarly, at least some functionalities of the bat assembly can be implemented on the base assembly.

For example, one embodiment of a baseball simulation device 450 can include a base assembly 452 having a plurality of emitters 460, 462, and 464 configured in a manner similar to, for example, FIG. 2. The simulation device 450 is further shown to include a bat assembly 454 having a plurality of sensors 470 and 472 configured in a manner similar to, for example, FIG. 2.

The bat assembly 454 can also include a processor 474 and an interface component 476. The processor 474 can be configured to determine various batting moves (for example, a swing 490) in a manner similar to that described above. The interface component 476 can be configured to transmit signals corresponding to such batting moves to the gaming platform (not shown).

In one embodiment, the base assembly 452 can include a plurality of user-activated input devices 480 such as buttons. To facilitate use of such input devices, the base assembly 452 can have an interface component 482 that provides signals from the input devices to the gaming platform.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Consequently, the scope of the invention should not be limited to the foregoing description, but should be defined by the appended claims.

What is claimed is:

1. A system for enhancing a simulated baseball game that is displayed on a display and is controllable by a first set of control devices such that user manipulation of the first set of control devices results in control signals in a first format being sent to a game controller such that the game controller generates display signals for displaying a simulated baseball play in accordance with the received control signals, the system comprising:
a baseball bat movement detection system that detects movement and orientation of a bat with respect to a reference location and provides signals indicative thereof; and
a controller that receives the signals and translates the received signals into control signals in the first format such that the baseball bat movement detection system can substitute for the first set of control devices for playing of the simulated baseball game.

2. The system of claim 1, wherein the baseball bat movement detection system comprises:
a bat assembly; and
a base assembly providing the reference location, wherein the bat assembly and the base assembly include a sensing system that allows detection of the movement and orientation of the bat assembly relative to the reference location.

3. The system of claim 2, wherein the bat assembly comprises an emitter assembly, and the base assembly comprises a sensor assembly.

4. The system of claim 3, wherein the emitter assembly includes first and second emitters spaced along the length the bat assembly by a first distance, and wherein the base assembly includes first and second sensors that are spaced apart by a second distance, such that the first and second sensors can detect the orientation of the bat assembly as the bat assembly swings over the sensor assembly.

5. The system of claim 4, wherein the first distance is approximately the same as the second distance.

6. The system of claim 4, wherein the bat assembly comprises the emitter assembly that is attachable to a bat.

7. The system of claim 4, wherein the sensor assembly further comprises a third sensor positioned on the base assembly so as to allow detection of an approach of the bat to an area above the base assembly.

8. The system of claim 7, wherein the base assembly comprises a home plate, and wherein the first and second sensors are positioned near the side edges near the front of the home plate, and wherein the third sensor is positioned near the rear of the home plate.

9. The system of claim 8, wherein the third sensor provides an initial timing signal for detection of the movement and orientation of the bat assembly.

10. The system of claim 10, wherein the first and second sensors provide timing signals that allow determination of orientation of the bat assembly as it swings over the first and second sensors.

11. The system of claim 10, wherein a direction of a hit is determined based on the relative timing of activation of the first and second sensors.

12. The system of claim 11, wherein the hit is considered to be a straight hit towards a center field if the activation of the first and second sensors occur within a selected time window.

13. The system of claim 12, wherein the hit is considered to be away from the center field if the activation of the first and second sensors occur outside of the selected time window.

14. The system of claim 13, wherein the hit is towards a left field if one of the first and second sensors positioned near the right front of the home plate is activated before the other sensor.

15. The system of claim 13, wherein the hit is towards a right field if one of the first and second sensors positioned near the left front of the home plate is activated before the other sensor.

16. The system of claim 9, wherein the third sensor allows detection of a bunt when the third sensor is activated for a selected duration.

17. The system of claim 16, wherein the first and second sensors are not activated during the bunt.

18. The system of claim 16, wherein signals from the first and second sensors are ignored when the third sensor is activated for the selected duration indicating the bunt.

19. The system of claim 7, wherein the first and second emitters emit electromagnetic signals.

20. The system of claim 19, wherein the electromagnetic signals comprise infrared signals.

21. The system of claim 19, wherein the first and second emitters emit electromagnetic signals at first and second frequencies, and the first sensor is configured to detect the first frequency signal and second sensor is configured to detect the second frequency signal.

22. The system of claim 21, wherein the first and second emitters can be switched between a first mode where the first and second signals have the first and second frequencies, respectively, and a second mode where the first and second signals have the second and first frequencies, respectively, thereby allowing use of the bat assembly by either a right handed or left handed user.

23. The system of claim 21, wherein the third sensor is configured to detect both first and second frequency signals.

24. The system of Claim 2, wherein the base assembly is configured to receive at least some of the first set of control devices such that the simulated baseball game can be played using either or both of the at least some of the first set of control devices and the baseball bat movement detection system.

25. The system of claim 2, wherein the base assembly comprises one or more user-operated input devices that facilitate playing of the game in conjunction with the baseball bat movement detection system.

26. The system of claim 25, wherein the one or more user-operated input devices provide instructions for base running plays.

27. The system of claim 2, wherein the base assembly comprises a firmware component that can be changed to accommodate different game softwares.

28. The system of claim 1, wherein the simulated baseball game is played on a personal computer.

29. The system of claim 1, wherein the simulated baseball game is played on a dedicated gaming platform.

30. The system of claim 29, wherein the gaming platform selected from the group consisting of PlayStation 1, PlayStation 2, PlayStation 3, XBOX, and XBOX360.

31. A method for enhancing a simulated baseball game that is displayed on a display and is controllable by a first set of control devices such that user manipulation of the first set of control devices results in control signals in a first format being sent to a game controller such that the game controller generates display signals for displaying a simulated baseball play in accordance with the received control signals, the method comprising:
detecting movement and orientation of a bat with respect to a reference location and providing signals indicative thereof; and
receiving the signals and translating the received signals into control signals in the first format so as to substitute for the first set of control devices for playing of the simulated baseball game.

32. A system for enhancing a simulated baseball game, the system comprising:
means for detecting movement and orientation of a bat with respect to a reference location; and
means for generating and providing signals indicative of the movement and orientation of the bat.

33. A system for enhancing a simulated baseball game that is displayed on a display and is controllable by a first set of control devices such that user manipulation of the first set of control devices results in control signals in a first format being sent to a game controller such that the game controller generates display signals for displaying a simulated baseball play in accordance with the received control signals, the system comprising:
a bat assembly;
a base assembly;
a plurality of signal emitters;
a plurality of sensors, wherein each sensor is configured to detect signals from one or more of the plurality of signal emitters;
wherein the plurality of signal emitters and the plurality of sensors are positioned on the bat assembly and the base assembly, wherein at least one of the plurality of signal emitters or the plurality of sensors is positioned on the bat assembly, and wherein at least one of the plurality of signal emitters or the plurality of sensors is positioned on the base assembly, such that sensing of the emitted signals by the plurality of sensors allows determination of movement and orientation of the bat assembly relative to the base assembly.

34. The system of claim 33, wherein the plurality of signal emitters are positioned on the bat assembly, and the plurality of sensors are positioned on the base assembly.

35. The system of claim 33, wherein the plurality of signal emitters are positioned on the base assembly, and the plurality of sensors are positioned on the bat assembly. 2
